(19) United States
(12) Patent Application Publication
(10) Pub. No.: US 2021/0365400 A1
(43) Pub. Date: Nov. 25, 2021

(54) ADAPTOR DEVICE

(71) Applicant: Faraday Technology Corp., Hsinchu (TW)

(72) Inventors: Ching-Lin Hsu, Hsinchu (TW); Chang-Hsien Lin, Hsinchu (TW)

(73) Assignee: Faraday Technology Corp., Hsinchu (TW)

(21) Appl. No.: 16/931,373

(22) Filed: Jul. 16, 2020

(30) Foreign Application Priority Data
May 19, 2020 (TW) 109116472

(51) Int. Cl. G06F 13/42; G06F 13/40

(52) U.S. Cl. CPC G06F 13/4282; G06F 2213/0042; G06F 13/4068

(57) ABSTRACT

An adaptor device including a first interface, a second interface, a negotiation circuit and a type C manager and controller is provided. The first interface is a universal serial bus (USB) 2.0 interface, and the second interface is a type C USB interface. When the first interface receives a first mode swap request, the type C manager and controller transmits a first mode swap signal in a type C format through the second interface according to the first mode swap request; when the second interface receives a second mode swap request, the negotiation circuit transmits a second mode swap signal in a USB 2.0 format through the first interface according to the second mode swap request.

### CROSS-REFERENCE TO RELATED APPLICATION

This application claims the priority benefit of Taiwan application no. 109116472, filed on May 19, 2020. The entirety of the above-mentioned patent application is hereby incorporated by reference herein and made a part of this specification.

### TECHNICAL FIELD

The invention relates to an adaptor device, and more particularly, to an adaptor device that can provide a mode swap between electronic devices of different interface formats.

### BACKGROUND

With the popularity of electronic devices today, it is an important function to perform a fast and convenient data transmission between electronic devices. Therefore, Universal Serial Bus (USB) has become a commonly used transmission interface.

With the evolution of USB technology, USB provides a variety of different transmission interfaces. In order to enable the data transmission between electronic devices of different USB formats, an adaptor device is needed as a transmission interface. However, as the adapter device between USB 2.0 and type C USB in today's products, modes of the connected electronic devices are fixed and cannot be changed, which limits the performance of the electronic device.

### SUMMARY

The invention provides an adaptor device capable of enabling a role swap operation between electronic devices of USB 2.0 interface and type C USB interface.

An adaptor device of the invention includes a first interface, a second interface, a negotiation circuit and a type C manager and controller. The first interface is a universal serial bus (USB) 2.0 interface, and the second interface is a type C USB interface. The negotiation circuit is coupled to the first interface. The type C manager and controller is coupled to the second interface and the negotiation circuit. Here, when the first interface receives a first mode swap request, the negotiation circuit transmits a first mode swap signal in a type C format through the second interface according to the first mode swap request; and when the second interface receives a second mode swap request, the negotiation circuit transmits a second mode swap signal in a USB 2.0 format through the first interface according to the second mode swap request.

Based on the above, the adaptor device proposed by the invention can be provided for the electronic devices of USB 2.0 and type C USB to connect with each other and perform the data transmission. Moreover, the adaptor device proposed by the invention can enable the electronic devices of USB 2.0 interface and the electronic device of the C-type USB interface to swap between a host mode and a device mode so as to improve a work efficiency for the electronic devices of different interface formats.

### BRIEF DESCRIPTION OF THE DRAWINGS

FIG. 1 illustrates a schematic diagram of an adaptor device in an embodiment of the invention.

FIG. 2A to FIG. 2D are flowcharts illustrating a mode setup method of the adaptor device in an embodiment of the invention.

FIG. 3 illustrates a schematic diagram of an adaptor device in another embodiment of the invention.

FIG. 4A and FIG. 4B are schematic diagrams illustrating a mode swap operation in the embodiment of FIG. 3.

### DETAILED DESCRIPTION

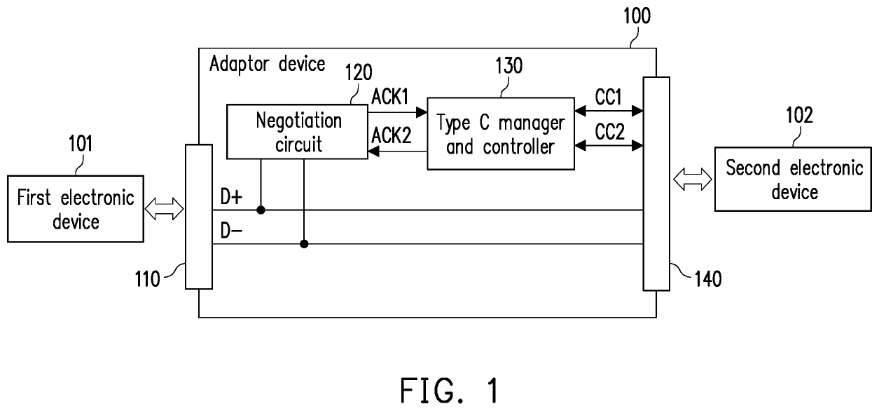

Referring to FIG. 1, FIG. 1 illustrates a schematic diagram of an adaptor device in an embodiment of the invention. An adaptor device 100 includes a first interface 130, a second interface 140, a negotiation circuit 120 and a type C manager and controller 130. The first interface 110 and the second interface 140 are used to connect to a first electronic device 101 and a second electronic device 102, respectively. In this embodiment, the first interface 110 is a universal serial bus (USB) 2.0 interface, and may also be a USB OTG (On-The-Go) interface of the USB 2.0 supplementary standard. The second interface 140 is a type C USB interface.

The negotiation circuit 120 is coupled to the first interface 110. The negotiation circuit 120 may be coupled to the first interface 110 through data lines D+ and D−. The type C manager and controller 130 is coupled to the second interface 140 and the negotiation circuit 120. The type C manager and controller 130 may be coupled to the second interface 140 through configuration channels CC1 and CC2.

Here, it should be noted that when the electronic devices 101 and 102 are respectively connected to the first interface 110 and the second interface 140, one of the electronic devices 101 and 102 may be initially set to a host mode, and the other one of the electronic devices 101 and 102 may be initially set to a device mode. In a type C USB format, the host mode may also be referred to as a source role, and the device mode be referred to as a sink role.

In this embodiment, when the first electronic device 101 intends to perform a mode swap and become the host mode, the first interface 110 may receive a mode swap request transmitted by the first electronic device 101, so that the type C manager and controller 130 can transmit a mode swap signal in a type C format through the second interface 140 to the second electronic device 102 according to the mode swap request. The second electronic device 102 may be swapped to the device mode according to the mode swap signal transmitted by the second interface 140. The first electronic device 101 may be correspondingly swapped to the host mode.

In detail, when first electronic device 101 transmits the mode swap request, the negotiation circuit 120 may receive the mode swap request through the first interface 110, generate an acknowledging signal ACK1 according to the mode swap request, and transmit the acknowledging signal ACK1 to the type C manager and controller 130. After the acknowledging signal ACK1 is received, the type C manager and controller 130 may use one of the configuration channels CC1 and CC2 according to the acknowledging signal ACK to generate and provide the mode swap signal to the second electronic device 102 according to a data role swap protocol.

In this embodiment, the data role swap protocol is a standard protocol for performing a mode swap operation in the type C USB device.

In addition, the first electronic device 101 may generate the mode swap request through the data lines D+ or D−. The mode swap request generated by the first electronic device 101 may be generated according to a host negotiation protocol (HNP). In other words, the first electronic device 101 may generate the mode swap request by pulling down one of the data lines D+ and D− (e.g., the data line D+) for a period of time. By determining whether the data line D+ is pulled down, the negotiation circuit 120 may determine that the mode swap request transmitted by the first electronic device 101 is received when a voltage of the data line D+ is pulled down for a time length longer than a preset threshold.

On the other hand, when the second electronic device 102 intends to perform the mode swap and become the host mode, the second interface 140 may receive another mode swap request transmitted by the second electronic device 102, so that the negotiation circuit 120 can transmit a mode swap signal in a USB 2.0 format through the first interface 110 according to the mode swap request. The first electronic device 101 may be swapped to the device mode according to the mode swap signal transmitted by the first interface 110. The second electronic device 102 may be correspondingly swapped to the host mode.

In this embodiment, the second electronic device 102 may generate the mode swap request by transmitting a data packet through the data role swap protocol. The type C manager and controller 130 receives the mode swap request through one of the configuration channels CC1 and CC2 and generates an acknowledging signal ACK2 according to the mode swap request. The type C manager and controller 130 transmits the acknowledging signal ACK2 to the negotiation circuit 120. The negotiation circuit 120 may use a data signal on one of the data lines D+ and D− according to the acknowledging signal ACK2 to generate the mode swap request according to the host negotiation protocol. In this way, the first electronic device 101 may be correspondingly swapped to the device mode, and the second electronic device 102 may be correspondingly swapped to the host mode.

The negotiation circuit 120 may generate the data signal by pulling down the voltage on one of the data lines D+ and D− (e.g., the data line D+), and generate the mode swap signal by pulling down the voltage on the data line D+ for a time length.

Incidentally, when the electronic device 101 is connected to the first interface 110, the adaptor device 100 may initialize a mode of the first electronic device 101 according to a voltage on an identification pin (ID pin) of the first interface 110 of USB 2.0. Among them, the voltage of the identification pin of a type A USB 2.0 connector is a ground voltage. The identification pin of a type B USB 2.0 connector is a floating state. In addition, when the electronic device 102 is connected to the second interface 140, the adaptor device 100 may initialize a mode of the second electronic device 102 according to a resistance on one of the configuration channels CC1 and CC2.

According to the above description, it can be known that the adaptor device 100 of this embodiment can be connected to the first electronic device 101 and the second electronic device 102 of different formats. In addition to the data transmission between the first electronic device 101 and the second electronic device 102, the mode swap requests of the first electronic device 101 and the second electronic device 102 may also be supported to effectively improve a use efficiency of the first electronic device 101 and the electronic device 102.

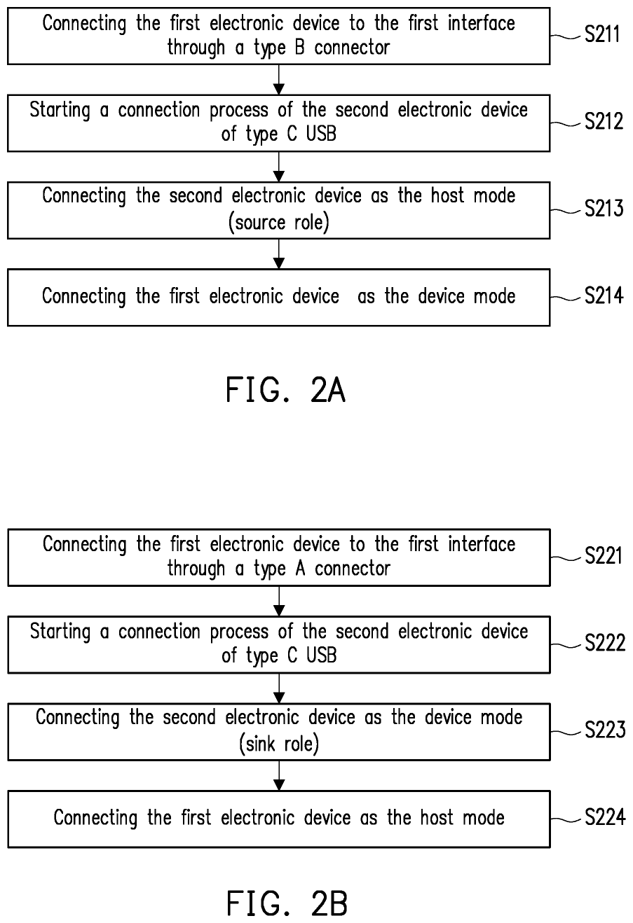

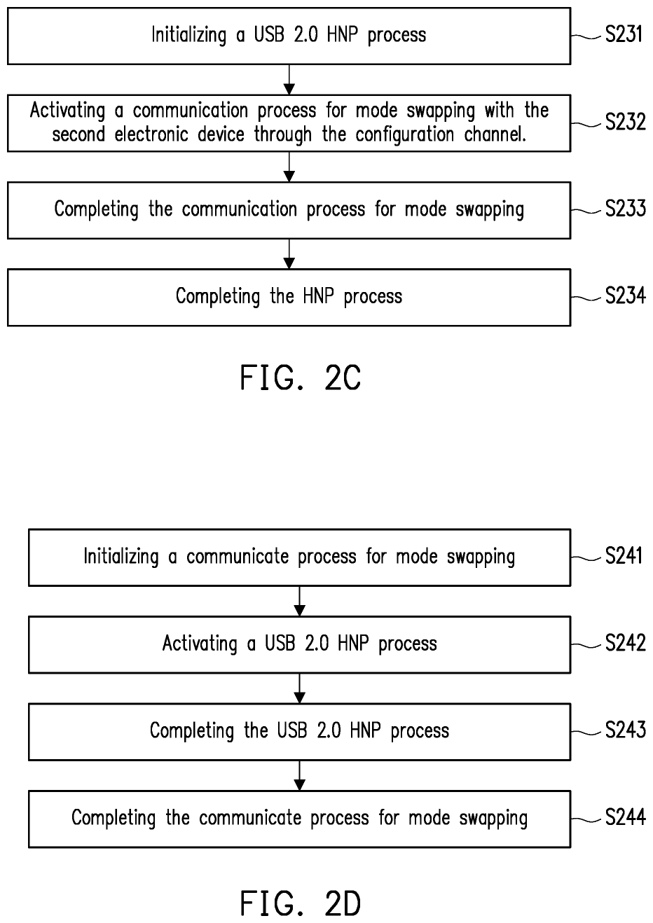

Referring to FIG. 2A to FIG. 2D, FIG. 2A to FIG. 2D are flowcharts illustrating a mode setup method of the adaptor device in an embodiment of the invention. FIG. 2A is an initializing operation flow of a mode of an electronic device in an embodiment of the invention. In step S211, the first electronic device is connected to the first interface through a type B connector; then, a connection process of the second electronic device of type C USB is started in step S212. In step S213, the second electronic device is connected to the host mode (i.e., the source role); the first electronic device is connected to the device mode in step S214.

FIG. 2B is an initializing operation flow of a mode of an electronic device in another embodiment of the invention. In FIG. 2B, in step S211, the first electronic device is connected to the first interface through a type A connector; then, a connection process of the second electronic device of type C USB is started in step S222. In step S223, the second electronic device is connected to the device mode (i.e., the sink role); the first electronic device is connected to the host mode in step S224.

FIG. 2C is a mode swap operation flow of an electronic device in an embodiment of the invention. In FIG. 2C, the first electronic device needs to be swapped to the host mode. In step S231, the first interface initializes a USB 2.0 HNP process with the first electronic device, and the first interface receives the mode swap request transmitted by the first electronic device. In step S232, a communication process for mode swapping with the second electronic device is activated through a configuration channel. After the communication process for mode swapping is completed (step S233), in step S234, the first interface may report the completion of the mode swap operation to the first electronic device through the HNP and complete the HNP process activated in step S231.

Here, the first interface may report the completion of the mode swap operation to the first electronic device by pulling up a voltage of one of a first data line and a second data line.

FIG. 2D is a mode swap operation flow of an electronic device in another embodiment of the invention. In FIG. 2D, the second electronic device needs to be swapped to the host mode. In step S241, the second interface initializes a communicate process for mode swapping with the second electronic device, and obtains the mode swap request proposed by the second electronic device. According to the mode swap request, a USB 2.0 HNP process may be activated in step S242 to perform an acknowledging operation with the first electronic device through the first interface. After the process of step S242 is completed in step S243, the second interface may inform the second electronic device that the communication process for mode swapping is completed in step S244.

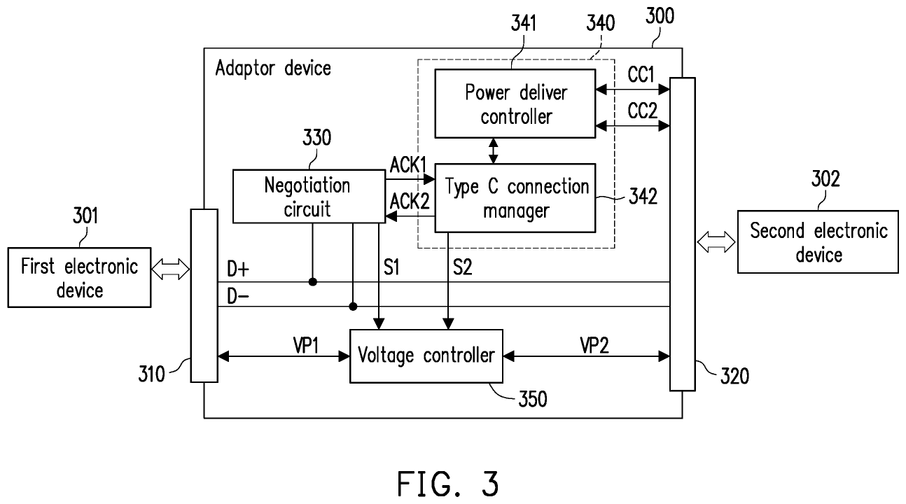

Referring to FIG. 3, FIG. 3 illustrates a schematic diagram of an adaptor device in another embodiment of the invention. An adaptor device 300 includes a first interface 310, a second interface 320, a negotiation circuit 330, a type C manager and controller 340 and a voltage controller 350. The first interface 310 and the second interface 320 are used to connect to a first electronic device 301 and a second electronic device 302, respectively. The type C manager and controller 340 includes a power deliver (PD) controller 341 and a type C connection manager 342. Here, the power deliver controller 341 and the type C connection manager 342 are coupled to each other, and the type C connection manager 342 is coupled to the negotiation circuit 330. The power deliver controller 341 is coupled to the second interface 320 through configuration channels CC1 and CC2. The type C connection manager 342 may perform a transmitting operation of acknowledging signals ACK1 or ACK2 with the negotiation circuit 330. The power deliver controller 341 may receive the mode swap request form the second interface 320 or transmit the mode swap signal to the second interface 320 through the configuration channels CC1 and CC2.

In this embodiment, the voltage controller 350 is coupled to the negotiation circuit 330 and the type C manager and controller 340, and is coupled to the first interface 310 and the second interface 320 through power lines VP1 and VP2, respectively. The voltage controller 350 controls a delivery path of a power according to mode setup states S1 and S2 of the first electronic device 301 and the second electronic device 302. Here, when the first electronic device 301 is set to the host mode and the second electronic device 302 is set to the device mode, the voltage controller 350 may transmit the power from the first electronic device 301 to the second electronic device 302 through the power lines VP1 and VP2 in that sequence. On the other hand, when the second electronic device 302 is set to the host mode and the first electronic device 301 is set to the device mode, the voltage controller 350 transmits the power from the second electronic device 302 to the first electronic device 301 through the power lines VP2 and VP1 in that sequence.

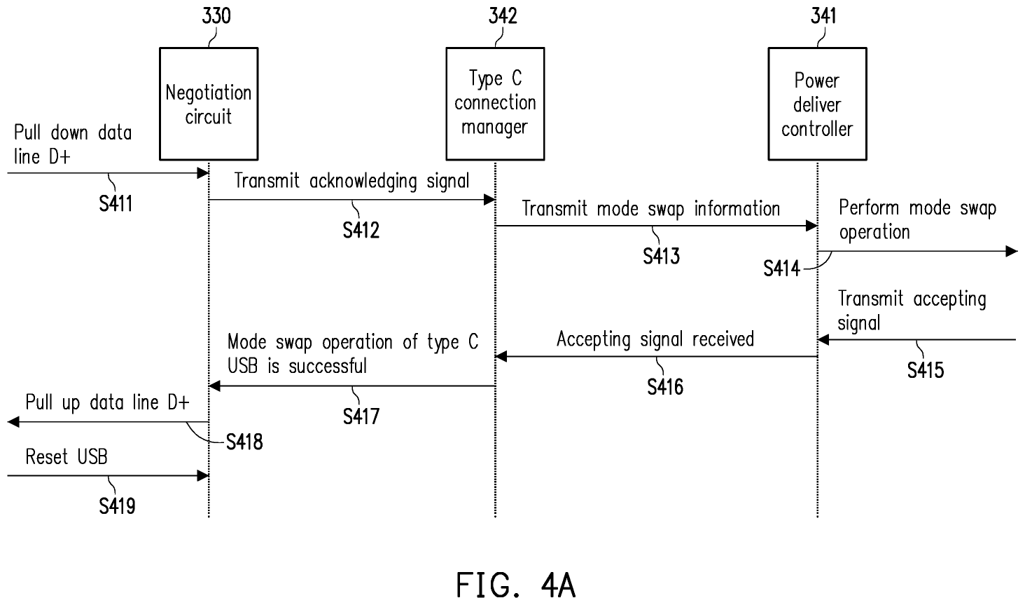

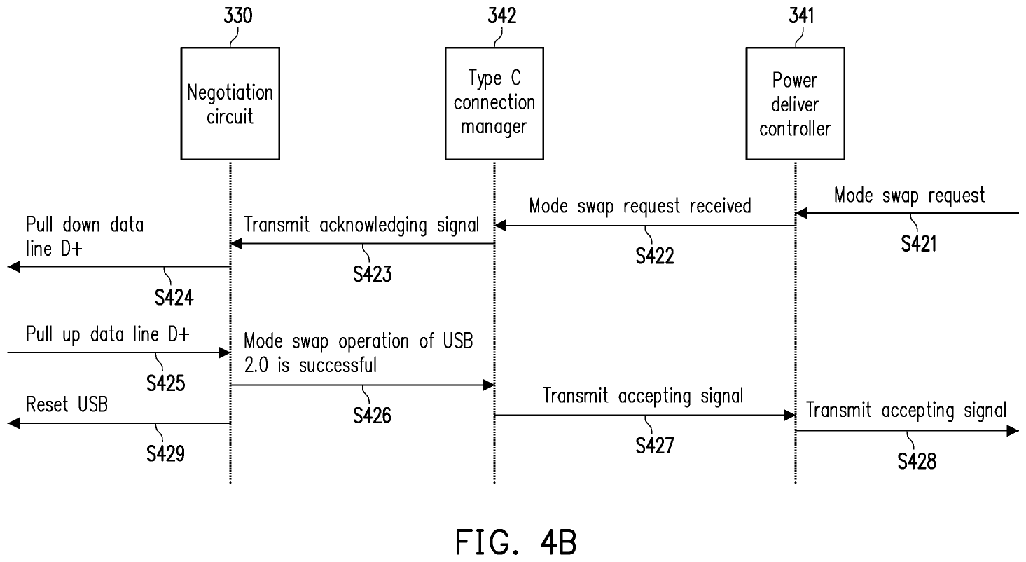

Referring to FIG. 3, FIG. 4A and FIG. 4B together, FIG. 4A and FIG. 4B are schematic diagrams illustrating a mode swap operation in the embodiment of FIG. 3. In FIG. 4A, in step S411, when the first electronic device needs to be swapped to the host mode, the negotiation circuit 330 detects that the data line D+ is pulled down, and transmits an acknowledging signal to the type C connection manager 342 in step S412. In step S413, the type C connection manager 342 transmits mode swap information to the power delivery controller 341 according to the received acknowledging signal. In step S414, the power delivery controller 341 performs the mode swap operation by transmitting a data packet to the second electronic device.

After the mode swap request is received by the second electronic device, the power delivery controller 341 may correspondingly receive an accepting signal in step S415, and inform the type C connection manager 342 of information regarding that the accepting signal is received. The type C connection manager 342 may notify the negotiation circuit 310 in step S417 that the mode swap operation of type C USB is successful. Then, in step S418, the negotiation circuit 310 pulls up the voltage of the data line D+ to let the first electronic device know that the mode swap request is completed. In step S419, the negotiation circuit 330 may perform a USB reset operation.

In FIG. 4B, when the second electronic device needs to be swapped to the host mode, in step S421, the power delivery controller 341 receives a mode swap request transmitted by the second electronic device, and informs the type C connection manager 342 of information regarding that the mode swap request is received in step S422. Next, in step S423, the type C connection manager 342 may transmit an acknowledging signal to the negotiation circuit 330. Then, in step S424, the negotiation circuit 330 pulls down the voltage of the data line D+ to let the first electronic device know that the mode swap operation is to be performed. In step S425, the first electronic device may pull up the voltage of the data line D+ to thereby inform the negotiation circuit 330 of a message regarding that the first electronic device accepts the mode swap operation. In step S426, the negotiation circuit 330 returns a message regarding that the mode swap operation of USB 2.0 is successful to the type C connection manager 342. In step S427, the type C connection manager 342 correspondingly transmits an accepting signal to the power delivery controller 341. Then, the power deliver controller 341 transmits the accepting signal to the second electronic device through configuration channels (step S428). In step S429, the negotiation circuit 330 may perform a USB reset operation.

In summary, the adaptor device according to the embodiment of the invention can be connected to the electronic devices of different USB formats. In addition to effectively completing the data transmission between electronic devices, the need of each electronic device mode swap may also be met to effectively improve the working efficiency of the system.

1. An adaptor device, comprising:
a first interface, which is a universal serial bus (USB) 2.0 interface;
a second interface, which is a type C USB interface;
a negotiation circuit, coupled to the first interface; and
a type C manager and controller, coupled to the second interface and the negotiation circuit; and
wherein when the first interface receives a first mode swap request, the type C manager and controller transmits a first mode swap signal in a type C format through the second interface according to the first mode swap request; and
when the second interface receives a second mode swap request, the negotiation circuit transmits a second mode swap signal in a USB 2.0 format through the first interface according to the second mode swap request.

2. The adaptor device of claim 1, wherein the negotiation circuit is coupled to a first data line and a second data line, and the type C manager and controller is coupled to a first configuration channel and a second configuration channel.

3. The adaptor device of claim 2, wherein the negotiation circuit receives the first mode swap request according to a host negotiation protocol through a data signal on one of the first data line and the second data line, and the negotiation circuit generates an acknowledging signal according to the first mode swap request and transmits the acknowledging signal to the type C manager and controller.

4. The adaptor device of claim 3, wherein the type C manager and controller uses one of the first configuration channel and the second configuration channel according to the acknowledging signal to generate the first mode swap signal according to a data role swap protocol.

5. The adaptor device of claim 2, wherein the type C manager and controller receives the second mode swap request through one of the first configuration channel and the second configuration channel, and the type C manager and controller generates an acknowledging signal according to the second mode swap request and transmits the acknowledging signal to the negotiation circuit.

6. The adaptor device of claim 5, wherein the negotiation circuit uses a data signal on one of the first data line and the second data line according to the acknowledging signal to generate the second mode swap request according to a host negotiation protocol.

7. The adaptor device of claim 1, further comprising:
a voltage controller, coupled to the negotiation circuit and the type C manager and controller, and controlling a delivery path of a power according to mode setup states of a first electronic device and a second electronic device respectively coupled to the first interface and the second interface.

8. The adaptor device of claim 7, wherein when the first electronic device is set to a host mode and the second electronic device is set to a device mode, the power is transmitted from the first electronic device to the second electronic device; when the second electronic device is set to the host mode and the first electronic device is set to the device mode, the power is transmitted from the second electronic device to the first electronic device.

9. The adaptor device of claim 7, wherein the negotiation circuit initializes a mode of the first electronic device according to a voltage on an identification pin of the first interface, and the type C manager and controller initializes a mode of the second electronic device according to a resistance on one of a first configuration channel and a second configuration channel of the second interface.

10. The adaptor device of claim 2, wherein the type C manager and controller comprises:
a type C connection manager, coupled to negotiation circuit; and
a power delivery controller, coupled to the type C connection manager, the first configuration channel and the second configuration channel.
